(19) United States
(12) Patent Application Publication
(10) Pub. No.: US 2025/0350062 A1
(43) Pub. Date: Nov. 13, 2025

(54) ELECTRICAL CONNECTOR WITH REMOVABLE FACEPLATE

(71) Applicant: Aptiv Technologies AG, Schaffhausen (CH)

(72) Inventors: Carlos Armando GONZALEZ DELGADILLO, Coahuila (MX); Pedro YABUR PACHECO, Coahuila (MX); Faviola RAMON, Coahuila (MX); Maria Fernanda AMADO, Coahuila (MX)

(21) Appl. No.: 18/659,486

(22) Filed: May 9, 2024

(51) Int. Cl. H01R 13/436

(52) U.S. Cl. CPC H01R 13/4367

(57) ABSTRACT

An electrical connector that includes a removeable faceplate is described. The removeable faceplate includes a primary lock and at least one terminal position assurance (TPA) feature coupled to the removeable faceplate by a hinge. The TPA feature is moveable via the hinge to be seated in an opening in a connector body to interact with terminal(s) carried in the connector body to secure the terminal(s) in the connector body.

### TECHNICAL FIELD OF THE INVENTION

This invention relates generally to electrical connectors, and more specifically electrical connectors that enable access to terminals carried by the connector.

### BACKGROUND

Electrical connectors are commonly used in many commercial, industrial, and military applications to implement power, signal, and data systems. For some applications, traditional connectors include terminal access windows integrated in a body of the connector that enable access to terminals carried in the connector body without first removing the terminals. In some examples, traditional connectors may be relatively expensive or complex to manufacture with reliable quality. A need exists for improvements in electrical connectors that enable terminal access that are relatively easy and/or inexpensive to manufacture, inspect, and install in comparison to traditional connectors.

### SUMMARY

Electrical connectors that include a removeable faceplate are described. As an example, an electrical connector includes a faceplate with a primary lock that secures the faceplate to a connector body. A terminal position assurance (TPA) feature is rotatably coupled to the faceplate. The faceplate is configured to rotatably seat the TPA feature into the connector body to secure one or more terminals in the connector body.

As another example, a method is described. The method includes securing a faceplate to a connector body that carries a plurality of terminals using a primary lock. The method further includes moving a terminal position assurance (TPA) feature rotatably coupled to the faceplate towards the connector body. The method further includes seating the TPA feature into the connector body to secure one or more of the plurality of terminals in the connector body.

As another example, a removeable faceplate is described. The removeable faceplate includes a primary lock configured to secure the faceplate to a connector body that carries a plurality of terminals. The removeable faceplate further includes a terminal position assurance (TPA) feature rotatably coupled to the faceplate to be seated in the connector body to secure one or more of the plurality of terminals in the connector body.

### BRIEF DESCRIPTION OF THE DRAWINGS

FIG. 1 depicts an isometric view of an electrical connector with a removeable faceplate according to some embodiments.

FIG. 2 is an exploded view of an electrical connector with a removeable faceplate according to some embodiments.

FIG. 3A is an isometric view showing a removeable faceplate according to some embodiments.

FIG. 3B is an isometric view showing an opposite side of a removeable faceplate according to some embodiments.

FIG. 4A is an isometric view showing a connector body according to some embodiments.

FIG. 4B is an isometric view showing an opposed side of the connector body depicted in FIG. 4A according to some embodiments.

FIG. 4C is a side view of the connector body depicted in FIG. 4A according to some embodiments.

FIG. 4D is a top-down view showing a bottom side of the connector body depicted in FIG. 4A according to some embodiments.

FIG. 4E is a front view of the connector body depicted in FIG. 4A according to some embodiments.

FIG. 5A is a cross section side view showing a removeable faceplate secured to a connector body in a pre-seated position of a terminal position assurance (TPA) feature according to some embodiments.

FIG. 5B is a cross section side view showing the removeable faceplate secured to the connector body in a pre-staged position of the terminal position assurance (TPA) feature according to some embodiments.

FIG. 5C is a cross section side view showing the removeable faceplate secured to the connector body in a fully staged position of the terminal position assurance (TPA) feature according to some embodiments.

FIG. 6 is a closeup view showing a TPA feature secured in a fully staged position in a connector body to reinforce a primary lock of a removeable faceplate according to some embodiments.

FIG. 7 is a top-down view of an assembled electrical connector according to some embodiments.

FIG. 8 is a flow diagram that depicts a method of assembling an electrical connector according to some embodiments.

### DETAILED DESCRIPTION

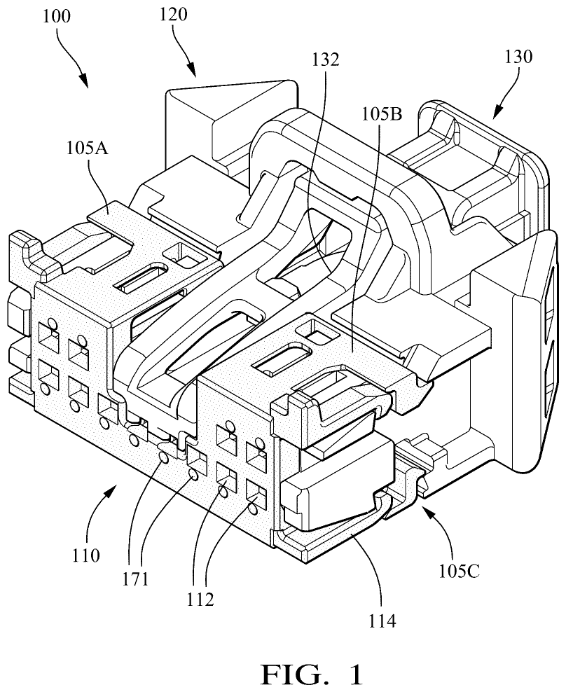

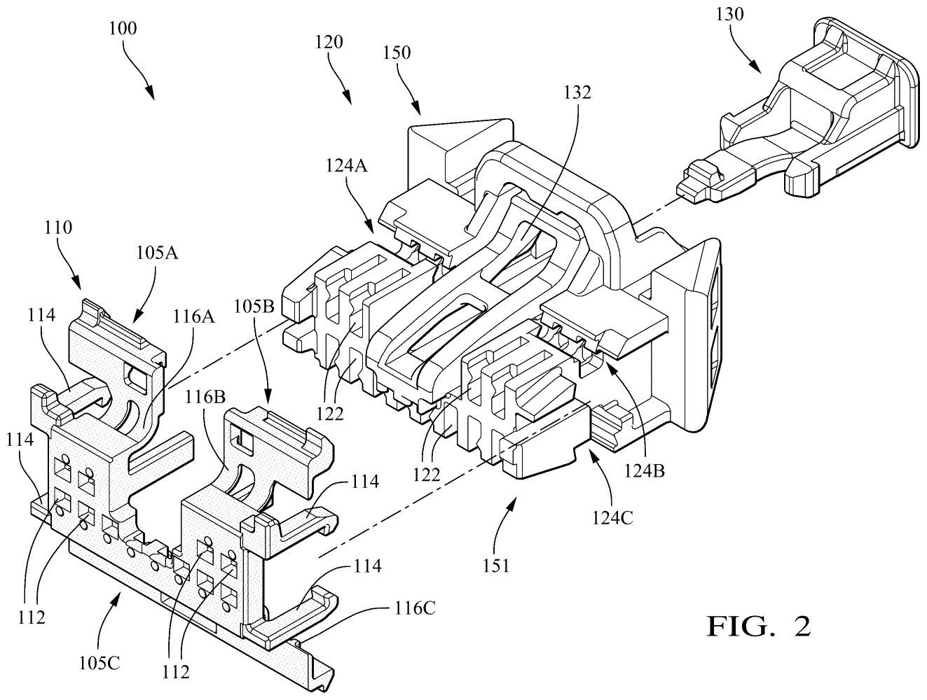

FIG. 1 depicts an isometric view of an electrical connector 100 with a removeable faceplate according to some embodiments. FIG. 2 is an exploded view of the electrical connector 100 according to some embodiments. FIG. 1 shows the electrical connector 100 fully assembled, while FIG. 2 shows an exploded view of the connector 100 according to some embodiments.

As shown in FIGS. 1 and 2, the electrical connector 100 includes a connector body 120, a connector position assurance (CPA) feature 130, and a removeable faceplate 110. The connector body 120 is configured to carry and secure a plurality of terminals (not shown in FIG. 1) in channels 122 through the connector body 120, and the CPA feature 130 is configured to be inserted through a CPA aperture 132 in the connector body 120 to secure the connector 100 as shown in the FIG. 1 example.

The removeable faceplate 110 includes a primary lock 114 which includes a pair of locking arms configured to interface with corresponding features of the connector body 120 and secure the removeable faceplate 110 in position on the connector body 120. The removeable faceplate 110 also includes a plurality of terminal windows 112 and/or probe windows 171 adjacent to the terminal windows 112 that, when the removeable faceplate 110 is seated on the connector body 120 as shown in FIG. 1, are aligned with the connector body 120 channels 122 and enable access to the terminals carried in the channels 122. The terminal windows 112 may enable visual inspect of the ends of terminals carried by the connector 100. As another example, probe windows 171 may enable a probe or other tool to be coupled to the terminals to measure one or more electrical characteristics associated with the terminals.

In addition, the removeable faceplate 110 includes one or more terminal position assurance (TPA) features 105A-105C that are rotatably coupled to the faceplate 110. In the example of FIG. 1, the TPA features 105A-105C are rotatably coupled to the faceplate 110 by respective hinge(s) 116A-116C. The hinge(s) 116A-116C position the TPA features 105A-105C to, when the faceplate 110 is seated on the connector body 120 with a primary lock 114 engaged, be rotated via the hinge(s) 116A-116C to be seated into the connector body 120, e.g., in an opening 124A-124C on the connector body 120 as shown in FIG. 1. When seated on the connector body 120 in a fully staged position, the TPA features 105A-105C interact with terminals carried in the connector body 120 to secure a position of the terminals, such that the terminals cannot be removed from the connector body 120 without disengaging the TPA feature(s) 105A-105C. In addition, when seated in the openings 124A-124C via the hinge(s) 116A-116C, the TPA features 105A-105C interact with and reinforce the primary lock 114.

Although not depicted in FIG. 1, in addition, the TPA features 105A-105C are configured to be seated in the openings 124A-124C in a pre-staged position in which the TPA features 105A-105C are secured to the connector body 120 but do not engage with terminals carried in the connector body 120 to secure the terminals in the connector body 120.

In some examples, a traditional electrical connector may include terminal windows that similarly enable access to terminals as an integrated part of the connector body. In some examples, it may be complicated and/or expensive to reliably manufacture such a traditional connector. For example, such a connector may require complicated tooling with a fine and narrow tip used to bore channels in the connector body to carry terminals, as well as to bore the terminal windows. Such tooling may be prone to frequent damage during the manufacturing process, which may often require the tooling to be replaced and/or repaired, and/or may require costly, time consuming, and/or difficult manual inspection of each connector to ensure the terminal windows are properly formed.

Connector 100 may be relatively simple to manufacture in comparison to traditional connectors. For example, connector 100 may be formed using simplified tooling that does not include a narrow tip prone to damage. In addition, in some examples, connector 100 may be easier to inspect to verify connector 100 was formed correctly. In still other examples, TPA features 105A-105C may be secured to the connector body 120 in a pre-staged position in which terminals can be installed or removed, thereby reducing a likelihood of snags or other disruptions during installation processes. In still other examples, connector 100 may operate with increased resilience to unintended decoupling in comparison to traditional connectors.

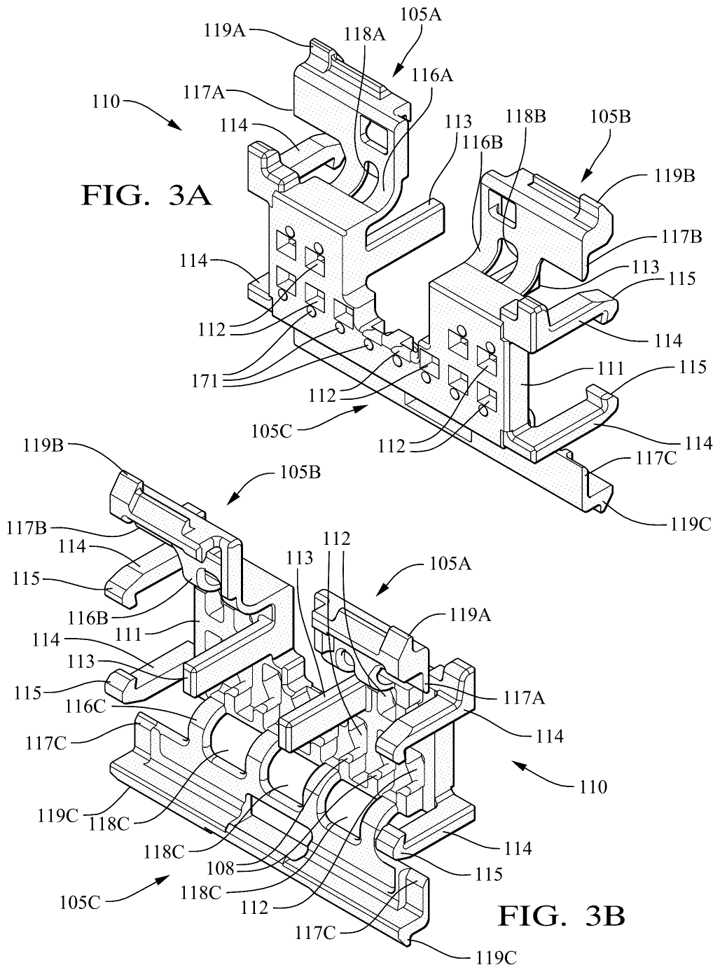

FIG. 3A is an isometric view showing a removeable faceplate 110 according to some embodiments. FIG. 3B is an isometric view showing an opposite side of a removeable faceplate 110 according to some embodiments.

As shown in FIGS. 3A and 3B, removeable faceplate 110 includes a faceplate body 111 that includes a plurality of terminal windows 112 and a plurality of probe windows 171 across the faceplate body 111. As shown in FIGS. 3A and 3B, the removeable faceplate 110 further includes a pair of alignment rails 113 that extend from the faceplate body 111, and a primary lock 114, which includes respective pairs of locking arms at respective sides of the faceplate body 111. As shown in FIGS. 3A and 3B, each locking arm include a locking end 115.

As also shown in FIGS. 3A and 3B, removeable faceplate 110 includes a plurality of terminal position assurance (TPA) features 105A-105C, which are rotatably coupled to the faceplate body 111 by respective hinge(s) 116A-116C. In the embodiment shown in FIGS. 3A and 3B, the removeable faceplate 110 includes a pair of TPA features 105A, 105B rotatably coupled to an upper portion of the faceplate body 111 by respective hinges 116A-116B, which are rotatably moveable independent from one another at an upper part of the faceplate body 111. As shown in FIGS. 3A and 3B, the removeable faceplate 110 further includes an elongate TPA feature 105C that extends across a width of the faceplate body 111 coupled to a lower part of the faceplate body 111 by an elongate hinge 116C. In some examples, hinges 116A-116C may be arranged such that TPA features 105A-105C are substantially parallel with faceplate body 111 (i.e., substantially parallel with the planar surface of faceplate body 111 that includes the terminal windows 112 and/or probe windows 171) before being installed on the connector body 120, as shown in the FIGS. 3A and 3B examples.

As also shown in FIGS. 3A and 3B, the TPA features 105A-105C each include an engagement end 119A-119C configured to interact with the connector body 120 to secure the TPA features 105A-105C in position in the connector body 120 as described in further detail below. As also shown in FIGS. 3A and 3B, the TPA features 105A-105C further include a lip 117C opposed to the engagement end 119A-119C which is configured to interact with primary locks 114 to reinforce the primary locks 114 when TPA features 105A-105C are seated in the connector body 120, as also described in further detail below.

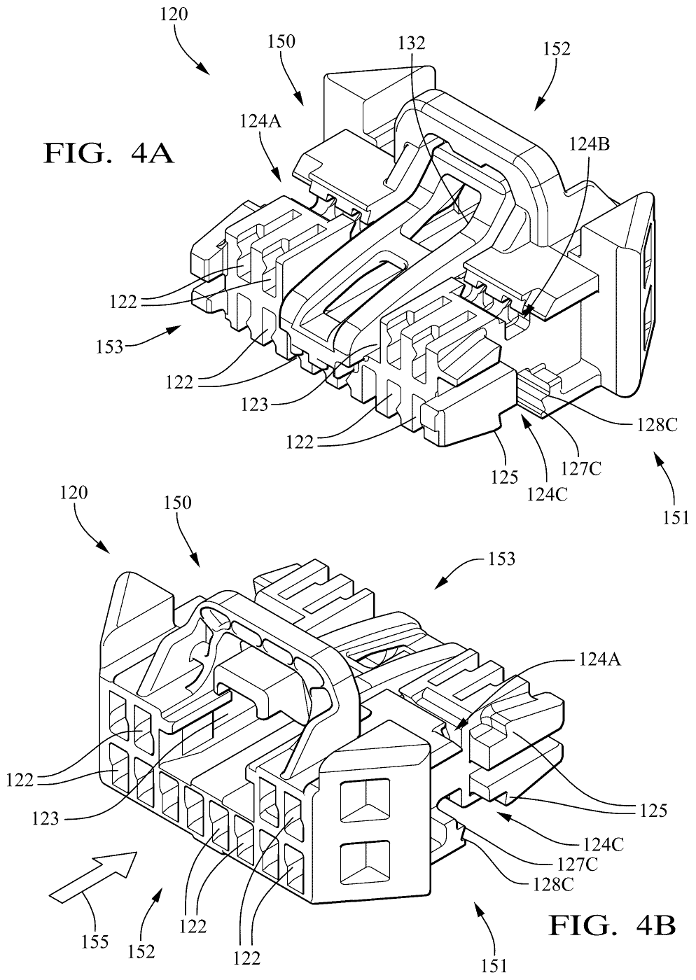

FIG. 4A is an isometric view showing a connector body 120 according to some embodiments. FIG. 4B is an isometric view showing an opposed side of the connector body 120 depicted in FIG. 4A according to some embodiments. FIG. 4C is a side view of the connector body 120 depicted in FIG. 4A according to some embodiments. FIG. 4D is a top-down view showing a bottom side of the connector body 120 depicted in FIG. 4A according to some embodiments. FIG. 4E is a front view of the connector body 120 depicted in FIG. 4A according to some embodiments.

Referring now to FIGS. 4A and 4B, the connector body 120 includes a top side 150 and a bottom side 151, and an insertion end 152 and an inspection end 153. The connector body 120 includes a plurality of terminal channels 122 that extend through the connector body 120 from the insertion end 152 to the inspection end 153. In the example of FIGS. 4A and 4B, the connector includes eight channels 122 arranged in a lower row, and four channels 122 arranged in an upper row on opposed sides of the CPA aperture 132. In other examples, a connector 100 as described herein may include more or fewer channels 122 to carry more or fewer terminals, for example a connector may include 8, 10, 12, 14, 16, 18, 20, or any number of channels arranged in two rows as shown in FIGS. 4A and 4B, or in more (i.e., three or more rows) or fewer (i.e., a single row) rows in other embodiments.

As shown in FIG. 4B, terminals (not shown in FIG. 4B) may be inserted into the channels at the insertion end 152 shown in FIG. 4B, moved in the insertion direction 155 until a lock of each terminal engages with a corresponding lock feature of each channel 122, securing the terminal in the connector body 120. The lock features may be configured such that inserting an already locked terminal further into the channel 122 disengages the locked terminal and allows the terminal to be removed from the channel 122.

As shown in FIGS. 4A and 4B, as well as FIG. 4E, the connector body 120 further includes a pair of tracks 123 on opposed sides of the CPA aperture 132, which are configured to receive alignment rails 113 of removeable faceplate 110 to align the removeable faceplate 110 when securing the removeable faceplate 110 to the connector body 120. In addition, the connector body 120 includes lock features 125 on opposed sides of the connector body 120, which primary lock 114 arms engage with to secure removeable faceplate 110 to connector body 120. In the embodiment shown, lock features 125 include a ramp that separates each pair of opposed primary lock 114 arms from one another when faceplate 110 is moved toward the connector body 120 with alignment rails 113 engaged with tracks 123, until the engagement ends 115 interface with an angled end of lock features 125, which secures the removeable faceplate 110 in a seated position on the connector body 120. When seated on the connector body 120, terminal windows 112 are aligned with channels 122 at the inspection end 153 to enable access to terminals carried in the channels 122.

As shown in FIGS. 4A-4D, the connector body 120 further includes openings 124A-124C. Each opening 124A-124C is configured to receive a respective TPA feature 105A-105C of the removeable faceplate 110, secured in position in the opening 124A-124C by engagement end 119A-119C interacting with the respective opening 124A-124C. For example, the engagement end 119A-119C may be configured to interact with at least one lock feature 127A-127C, 128A-128C, defined in the respective opening 124A-124C to secure the respective TPA feature 105A-105C in the opening 124A-124C. As shown in FIG. 4A, connector body 120 includes a pair of openings 124A, 124B on top side 150, and an opening 124C on the bottom side 151 of connector body 120. As shown in the example of FIG. 4D, opening 124C is elongate and extends across a width of the connector body 120, and includes a lock feature 127C and a lock feature 12C8.

Referring to FIG. 4C, openings 124B and 124C each include a first lock feature 127B, 127C that defines a pre-staged position of the TPA features 105B and 105C in which TPA features 105B and 105C are secured in position on the connector body 120 and terminals can be installed in or removed from the channels 122, and a second lock feature 128B, 128C that defines a fully staged position of the TPA features 105B and 105C in which the respective TPA feature 105C, 105C engages with terminals carried by the connector body 120 channels 122 secure the terminals in the channels 122.

Referring back to FIGS. 4A and 4B, hinges 116A-116C are operable to position TPA features 105A-105C to be rotatably towards the connector body 120 and seated into the connector body 120 via openings 124A-124C to interact with terminals carried in the connector body 120, and to interact and reinforce a primary lock 114 of the removeable faceplate 110. In this manner, the TPA features 105A-105C may be configured to reinforce the primary lock 114 i.e., by exerting an opposed force upon the primary lock 114 to maintain the primary lock 114 in position on connector body 120 (e.g., with locking ends 115 of primary lock engaged with lock features 125).

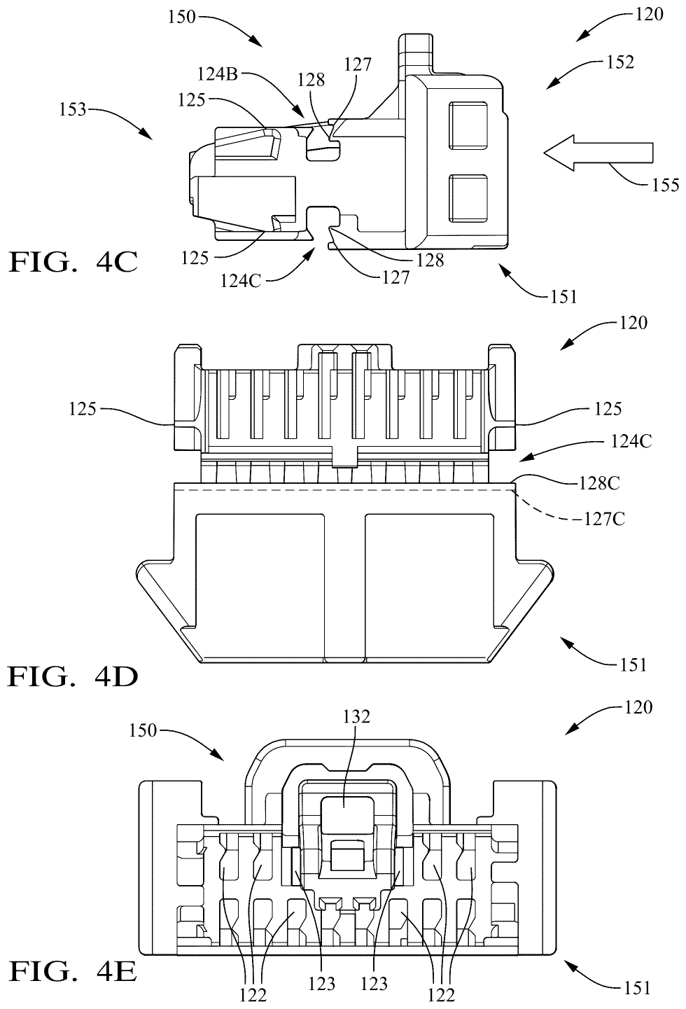

FIGS. 5A-5C are cross section side views of a connector 100 in various stages of assembly according to some embodiments. FIG. 5A is a cross section side view showing a removeable faceplate 110 secured to a connector body 120 in a pre-seated position of a terminal position assurance (TPA) feature 105B, 105C according to some embodiments. As shown in the FIG. 5A example, the removeable faceplate 110 has been seated on the inspection end 153 of the connector body 120 and locked in position, with primary locks 114 engaged with corresponding lock features 125 (not visible in the cross section view of FIG. 5A). Positioned as shown in FIG. 5A, terminal windows 112 are aligned with channels 122 to enable access to terminals 140 carried in the channels 122. In some embodiments as shown, hinges 116A-116C (hinges 116B and 116C are visible in the FIG. 5A example) are formed such that TPA features 105A-105C are arranged at a substantially 90 degree angle relative to the connector body 120 in the pre-seated position shown in FIG. 5A.

According to the cross section view shown in FIG. 5A, two terminal(s) 140 are shown seated in the channels 122 of connector body 120, an upper terminal and a lower terminal. The terminal(s) 140 were inserted in channels 122 at insertion end 152 and moved forward in the channels 122 towards the inspection end 153 of the connector body 120. As depicted, the terminal(s) 140 have been moved into channels 122 until terminal locks 149 engaged by snapping outward into a depression formed in each channel 122, thereby locking the terminal(s) 140 in the channels 122. In the pre-staged position, the terminal(s) 140 may also be removed from the channels 122, by moving the terminal(s) 140 further forward in the insertion direction 155 to release the terminal locks 149 such that terminal(s) 140 can be removed from the channels 122 (i.e., in a direction opposed to the depicted insertion direction 155).

In some examples, when terminal(s) 140 are seated and locked in the channels 122 as shown in FIG. 5A, the respective ends of each terminal may be positioned between alignment features 108 depicted in the FIG. 3B example, which align each terminal 140 with a respective terminal window 112 of the removeable faceplate 110.

FIG. 5B is a cross section side view showing the removeable faceplate 110 secured to the connector body 120 in a pre-staged position of the terminal position assurance (TPA) feature 105A-105C according to some embodiments. As shown in the FIG. 5B example, the terminal position assurance feature 105B has been rotatably moved from the roughly 90 degree pre-seated position of FIG. 5A into opening 124B in connector body 120 until engagement end 119B interacts with lock feature 127B in opening 124B. Similarly, terminal position assurance feature 105C has been rotatably moved from the pre-seated position of FIG. 5A towards opening 124C in connector body 120 until engagement end 119C interacts with lock feature 127C in opening 124C. In the pre-staged position shown in FIG. 5B, the TPA features 105A-105C are secured to the connector body 120 via lock features 127A-127C, but positioned to not interact with terminal(s) 140. As shown in FIG. 5B, in the pre-staged position, TPA features 105A-105C do not engage with a surface 141 of the terminal(s) 140 to inhibit the terminal(s) 140 from being removed from channels 122. In the pre-staged position of the TPA features 105A-105C, the terminals 140 can be inserted in the channels 122 and locked in position in the channels 122, and/or removed from the channels 122.

FIG. 5C is a cross section side view showing the removeable faceplate 110 secured to the connector body 120 in a fully staged position of the terminal position assurance (TPA) feature 105A-105C according to some embodiments. As shown in the FIG. 5C example, the TPA features 105B and 105C have each been moved further into the respective openings 124B, 124C, past the lock feature 127B, 127C until the respective engagement ends 119B, 119C interact with lock features 128B, 127C in the openings 124B, 124C. In the fully staged position shown in FIG. 5C, the TPA features 105B, 105C extend into the channels 122 in the connector body 120 to engage with a surface 141 of the terminal(s) 140, which secures the terminal(s) 140 in the channels 122 (i.e., prevents/inhibits the terminal(s) 140 from being moved in a direction opposed to the insertion direction 155), unless the TPA features 105A-105C are released by an operator (e.g., by moving the TPA features 105A-105C away from the lock feature 128A-128C in the respective openings 124A-124C) to release the TPA features 105A-105C. In some examples, as depicted in FIG. 5C, in the TPA features 105A-105C also include a lip 117A-117C opposed to the engagement end 119A-119C operable to reinforce a primary lock 114 of the removeable faceplate 110 the staged position.

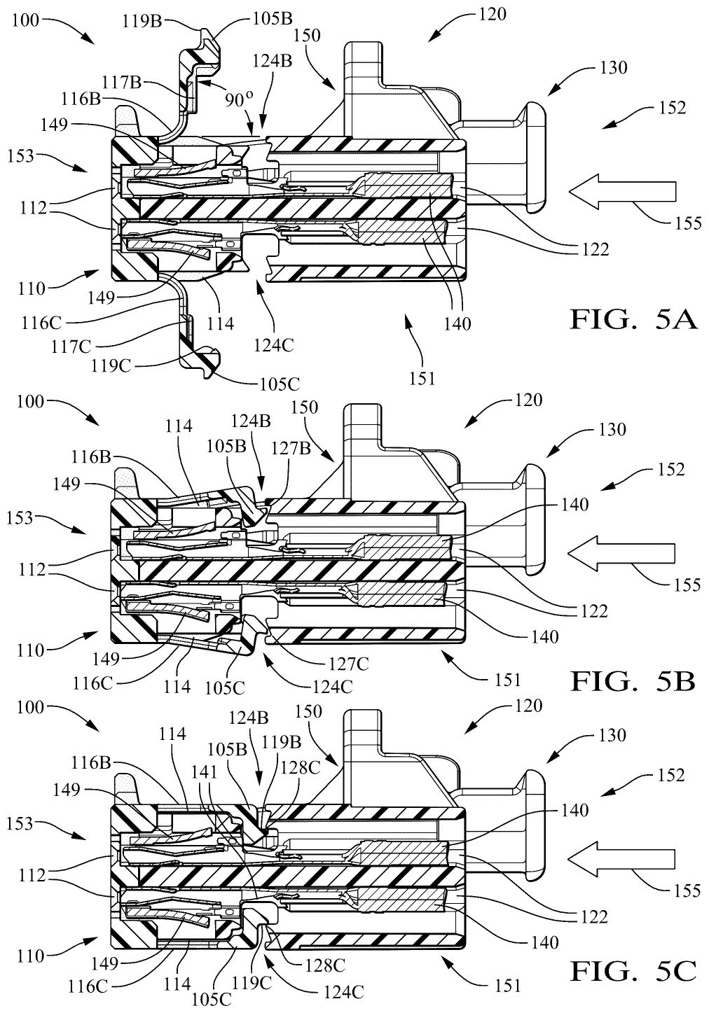

FIG. 6 is a closeup view showing a TPA feature 105B secured in a fully staged position in a connector body 120 as shown in the example of FIG. 5C according to some embodiments. As show in FIG. 6, the TPA feature 105B includes a lip 117B opposed to engagement end 119B that operates to engage with and overlap the locking ends 115 of each primary lock 114 of the removeable faceplate 110, which reinforces the primary lock 114. As shown in FIG. 6, the lip 117B includes an angled edge that corresponds to and engages with an angled surface of the primary lock 114 locking end 115. Although not depicted in a close-up view as shown in FIG. 6, TPA features 105A and 105C may each include a lip 117A, 117C that similarly reinforces the respective engagement ends 115 of one or multiple of the respective arms of primary lock 114. As depicted and described, the TPA features 105A-105C serve a dual purpose, to engage with terminals 140 and secure them in channels 122 and to interact with primary lock 114 to reinforce the primary lock 114 to secure the removeable faceplate 110 to connector body 120 as shown in FIG. 6, thereby rendering connector 100 more resilient to intended disconnection.

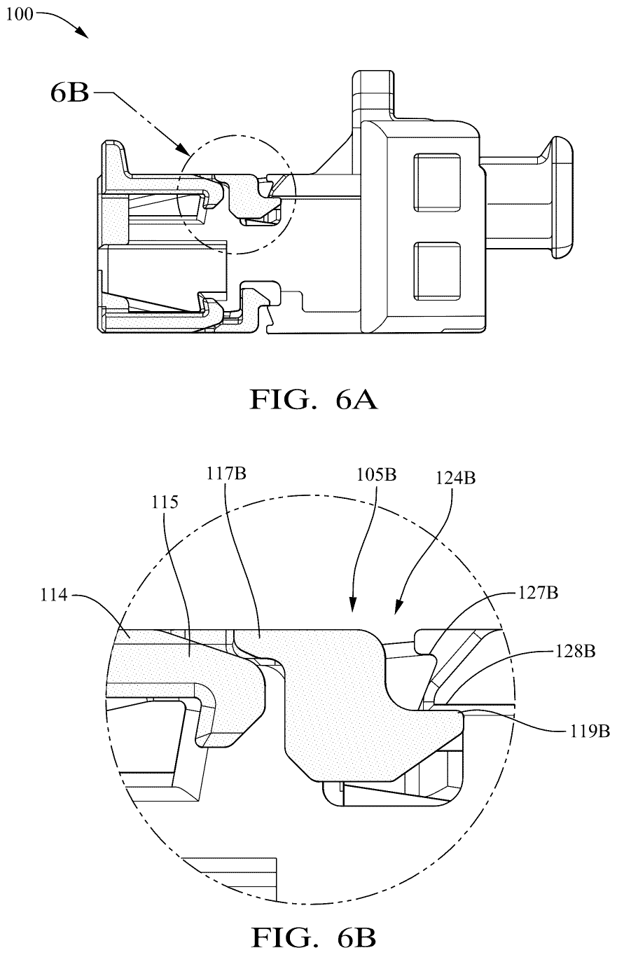

FIG. 7 is a top-down view of an assembled electrical connector 100 according to some embodiments. As shown in the example of FIG. 7, in some embodiments, removeable faceplate 110 includes visual inspection windows 118A, 118B. The visual inspection windows 118A, 118B may enable an operator to visually inspect terminals that are carried in the connector body 120 channels 122 without removing the terminals from the connector 100. In some examples, the visual inspection windows 118A, 118B are formed in the respective hinges 116A-116B of the removeable faceplate 110, and are sized, shaped, and positioned to align with corresponding windows formed in the connector body 120 to enable visual inspection of terminals carried in the connector body 120. In some examples, the visual inspection windows 118A, 118B enable an operator to visually inspect the terminal(s) 140 along a length of the terminals from above and/or below, as opposed to terminal windows 112, which enable visual or other inspection (e.g., coupling a probe or other tool) of the respective ends of the terminal(s) 140.

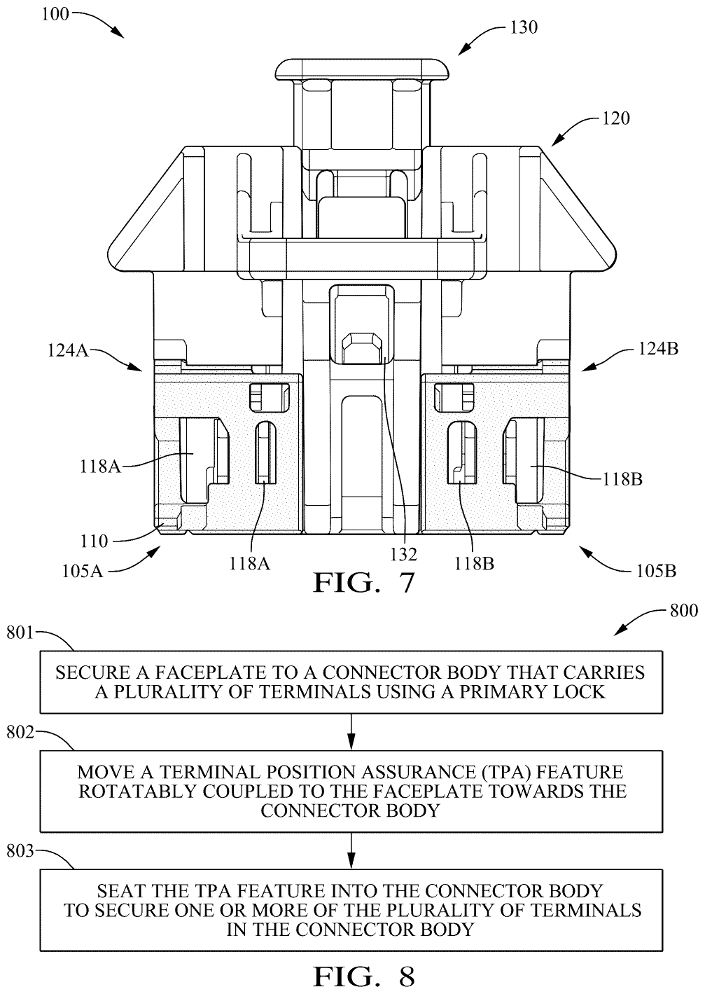

FIG. 8 is a flow diagram that depicts a method of assembling an electrical connector according to some embodiments. As shown in FIG. 8, at 801, the method includes securing a faceplate (e.g., 110) to a connector body (e.g., 120) that carries a plurality of terminals (e.g., 140) using a primary lock (e.g., 114). As shown in FIG. 8, at 802, the method includes moving a terminal position assurance (TPA) feature (e.g., 105A-105C) rotatably coupled to the faceplate towards the connector body. In some examples, the TPA feature is rotatably coupled to the faceplate by a hinge (e.g., 116A-116C). As shown in FIG. 8, at 803, the method includes seating the TPA feature into the connector body (e.g., in an opening (e.g., 124A-124C) to secure one or more of the plurality of terminals in the connector body.

In some examples, seating the TPA feature into the connector body reinforces the primary lock. In some examples, seating the TPA feature into the connector body comprises causing an engagement end (e.g., 119A-119C) of the TPA feature to interact with a corresponding lock feature (e.g., 127A-127C, 128A-128C) that secures the TPA feature in the connector body. In some examples, seating the TPA feature into the connector body includes causing a lip (e.g., 117A-117C) of the TPA feature opposed to the engagement end to engage with the primary lock to reinforce the primary lock.

In some examples, seating the TPA feature into the connector body includes causing the engagement end (e.g., 119A-119C) to engage with a lock feature (e.g., 128A-128C) in the opening (e.g., 124A-124C) in a fully staged position in which the TPA feature interacts with a surface (e.g., 141) of a terminal (e.g., 140) carried by the connector body to lock the plurality of terminals in the connector body. In some examples, the lock feature is a first lock feature and the method further includes seating the TPA feature in the opening by causing the engagement end to interact with a second lock feature (e.g., 127A-127C) in the opening (124A-124C) in a pre-staged position of the TPA feature in which one or more terminals carried in the connector body are insertable and/or removeable from the connector body.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

### DISCUSSION OF POSSIBLE EMBODIMENTS

The following are non-exclusive descriptions of possible embodiments of the present invention.

As one example, in some aspects, an electrical connector includes a faceplate with a primary lock that secures the faceplate to a connector body. The electrical connector further includes and a terminal position assurance (TPA) feature rotatably coupled to the faceplate. The faceplate is configured to rotatably seat the TPA feature into the connector body to secure one or more terminals in the connector body.

The electrical connector of the preceding paragraph may optionally include, additionally and/or alternatively, any one or more of the following features, configurations and/or additional components alone or in combination with one another.

According to one example, in some aspects, the TPA feature is configured to reinforce the primary lock. According to another example, in some aspects, the faceplate includes a hinge that couples the TPA feature to the faceplate to rotatably seat the TPA feature into the connector body. According to another example, in some aspects, the faceplate is configured to rotatably seat the TPA feature in an opening in the connector body. According to another example, in some aspects, the TPA feature includes an engagement end configured to be inserted in the opening to secure the TPA feature in the connector body. According to another example, in some aspects, the TPA feature includes a lip opposed to the engagement end that reinforces the primary lock. According to another example, in some aspects, the opening includes a lock feature that secures the engagement end in a fully staged position in which the TPA feature interacts with a surface of a terminal carried by the connector body to lock the terminal in the connector body. According to another example, in some aspects, the lock feature is a first lock feature, and the opening includes a second lock feature that secures the engagement end in a pre-staged position of the TPA feature in which one or more terminals carried in the connector body are insertable or removeable from the connector body. According to another example, in some aspects, the TPA feature comprises a pair of TPA features coupled to the faceplate by a pair of hinges, and the pair of TPA features are each independently configured to be rotatably seated into the connector body and seated in one of a pair of openings in the connector body to engage with respective terminals carried in the connector body to secure the respective terminals in the connector body. According to another example, in some aspects, the TPA feature is a first TPA feature coupled to the faceplate via a first hinge and configured to be rotatably seated in an opening in a first side of the connector body to secure at least one terminal carried in the connector body, and the removeable faceplate further includes a second TPA feature coupled to the faceplate via a second hinge and configured to be rotatably seated in a second opening on a second side of the connector body to secure at least one other terminal carried in the connector body.

According to another example, in some aspects, the TPA feature comprises an elongate TPA feature coupled to the faceplate by a single hinge and seated in an opening that extends across a width of the connector body. According to another example, in some aspects, the electrical connector further includes visual inspection windows formed through the TPA feature and/or the connector body to enable visual inspection of one or more terminals carried by the connector body without disengaging the TPA feature from the connector body. According to another example, in some aspects, the faceplate includes a plurality of terminal windows that enable visual inspection and/or probing of ends of one or more terminals carried in the connector body. According to another example, in some aspects, the TPA feature is arranged at an angle of substantially 90 degrees relative to the connector body when the faceplate is secured to the connector body in a pre-seated position of the TPA feature.

As one example, in some aspects, a method includes securing a faceplate to a connector body that carries a plurality of terminals using a primary lock. The method further includes moving a terminal position assurance (TPA) feature rotatably coupled to the faceplate towards the connector body. The method further includes seating the TPA feature into the connector body to secure one or more of the plurality of terminals in the connector body.

The method of the preceding paragraph may optionally include, additionally and/or alternatively, any one or more of the following features, configurations and/or additional steps alone or in combination with one another.

As one example, in some aspects, the TPA feature is rotatably coupled to the faceplate via a hinge. As another example, in some aspects, seating the TPA feature in the opening reinforces the primary lock. As another example, in some aspects, seating the TPA feature into the connector body includes causing an engagement end of the TPA feature to interact an opening in the connector body. As another example, in some aspects, seating the TPA feature into the connector body includes causing a lip opposed to the engagement end to interact with the primary lock to reinforce the primary lock. As another example, in some aspects, seating the TPA feature in the opening includes causing the engagement end to interact with a first lock feature in the opening in a fully staged position in which the TPA feature is arranged to interact with a surface of a terminal carried by the connector body to lock the terminal in the connector body. As another example, in some aspects, seating the TPA feature in the opening includes causing the engagement end to interact with a second lock feature in the opening in a pre-staged position of the TPA feature in which one or more terminals carried in the connector body are insertable and/or removeable from the connector body.

According to another example, in some aspects, a removeable faceplate includes a primary lock configured to secure the faceplate to a connector body that carries a plurality of terminals. The removeable faceplate further includes a terminal position assurance (TPA) feature rotatably coupled to the faceplate to be seated into the connector body to secure one or more of the plurality of terminals in the connector body. The electrical connector of the preceding paragraph may optionally include, additionally and/or alternatively, any one or more of the following features, configurations and/or additional components. According to one example, in some aspects, the TPA feature seated in the opening reinforces the primary lock.

1. An electrical connector comprising:
a faceplate with a primary lock that secures the faceplate to a connector body;
a terminal position assurance (TPA) feature rotatably coupled to the faceplate; and
the faceplate is configured to rotatably seat the TPA feature into the connector body to secure one or more terminals in the connector body.

2. The electrical connector of claim 1, wherein the TPA feature is configured to reinforce the primary lock.

3. The electrical connector of claim 1, wherein the faceplate includes a hinge that couples the TPA feature to the faceplate to rotatably seat the TPA feature into the connector body.

4. The electrical connector of claim 3, wherein the faceplate is configured to rotatably seat the TPA feature in an opening in the connector body.

5. The electrical connector of claim 4, wherein the TPA feature includes an engagement end configured to be inserted in the opening to secure the TPA feature in the connector body.

6. The electrical connector of claim 5, wherein the TPA feature includes a lip opposed to the engagement end that reinforces the primary lock.

7. The electrical connector of claim 5, wherein the opening includes a lock feature that secures the engagement end in a fully staged position in which the TPA feature interacts with a surface of a terminal carried by the connector body to lock the terminal in the connector body.

8. The electrical connector of claim 5, wherein the lock feature is a first lock feature, and wherein the opening includes:
a second lock feature that secures the engagement end in a pre-staged position of the TPA feature in which one or more terminals carried in the connector body are insertable or removeable from the connector body.

9. The electrical connector of claim 1, wherein the TPA feature comprises a pair of TPA features coupled to the faceplate by a pair of hinges, wherein the pair of TPA features are each independently configured to be rotatably seated into the connector body and seated in a one of a pair of openings in the connector body to engage with respective terminals carried in the connector body to secure the respective terminals in the connector body.

10. The electrical connector of claim 1, wherein the TPA feature is a first TPA feature coupled to the faceplate via a first hinge and configured to be rotatably seated in an opening in a first side of the connector body to secure at least one terminal carried in the connector body, and further comprising:
a second TPA feature coupled to the faceplate via a second hinge and configured to be rotatably seated in a second opening on a second side of the connector body to secure at least one other terminal carried in the connector body.

11. The electrical connector of claim 1, wherein the TPA feature comprises an elongate TPA feature coupled to the faceplate by an elongate hinge and rotatably seated in an opening that extends across a width of the connector body.

12. The electrical connector of claim 1, further comprising:
visual inspection windows formed through the TPA feature and/or the connector body to enable visual inspection of one or more terminals carried by the connector body without disengaging the TPA feature from the connector body.

13. The electrical connector of claim 1, wherein the faceplate includes a plurality of terminal windows that enable visual inspection and/or probing of ends of one or more terminals carried in the connector body.

14. The electrical connector of claim 1, wherein the TPA feature is arranged at an angle of substantially 90 degrees relative to the connector body when the faceplate is secured to the connector body in a pre-seated position of the TPA feature.

15. A method, comprising:
securing a faceplate to a connector body that carries a plurality of terminals using a primary lock;
moving a terminal position assurance (TPA) feature rotatably coupled to the faceplate towards the connector body; and
seating the TPA feature into the connector body to secure one or more of the plurality of terminals in the connector body.

16. The method of claim 15, wherein seating the TPA feature into the connector body comprises causing an engagement end of the TPA feature to interact with an opening in the connector body.

17. The method of claim 16, wherein seating the TPA feature in the opening includes causing the engagement end to interact with a first lock feature in a fully staged position in which the TPA feature interacts with a surface of a terminal carried by the connector body to lock the terminal in the connector body.

18. The method of claim 17, wherein seating the TPA feature in the opening includes causing the engagement end to interact with a second lock feature in a pre-staged position of the TPA feature in which one or more terminals carried in the connector body are insertable and/or removeable from the connector body.

19. A removeable faceplate, comprising:
a primary lock configured to secure the faceplate to a connector body that carries a plurality of terminals; and
a terminal position assurance (TPA) feature rotatably coupled to the faceplate to be seated into the connector body to secure one or more of the plurality of terminals in the connector body.

20. The removeable faceplate of claim 19, wherein the TPA feature seated into the connector body reinforces the primary lock.
